(19) United States
(12) Patent Application Publication
(10) Pub. No.: US 2024/0295885 A1
(43) Pub. Date: Sep. 5, 2024

(54) METHOD FOR NAVIGATION OF AN UNMANNED AUTONOMOUS VEHICLE, UNMANNED AUTONOMOUS VEHICLE, AND ITS USE

(71) Applicant: Wesley LORREZ, Waregem (BE)

(72) Inventor: Wesley LORREZ, Waregem (BE)

(21) Appl. No.: 18/550,275

(22) PCT Filed: Mar. 15, 2022
(86) PCT No.: PCT/IB2022/052327

§ 371 Date: Sep. 12, 2023

(30) Foreign Application Priority Data
Mar. 15, 2021 (BE) BE2021/5195
Feb. 2, 2022 (DE) DE 20-2022-100-58

(51) Int. Cl. G05D 1/689; A01D 34/00; A01D 101/00; G01C 21/00; G05D 105/80

(52) U.S. Cl. CPC G05D 1/689; G01C 21/3826; G01C 21/3848; A01D 34/008; A01D 2101/00; G05D 2105/87

(57) ABSTRACT

The present invention relates to a method for navigating an unmanned autonomous vehicle on a terrain, comprising moving the vehicle on the terrain, wherein the camera captures images of the terrain, wherein at least two images comprise identical points; creating a map based on the images; autonomous navigation of the vehicle based on the map created; wherein the vehicle is first moved along a perimeter in the terrain, wherein a first set of images is captured, after which a map of the perimeter is created based on the first set, followed by autonomous exploration of the terrain based on the created map of the perimeter, wherein a second set of images is created, after which the map of the terrain is created on the basis of the first and the second set. The invention also relates to an unmanned autonomous vehicle and a use.

### TECHNICAL FIELD

The invention relates to a method for navigation of an unmanned autonomous vehicle in a defined part of a terrain.

### PRIOR ART

Unmanned autonomous vehicles are known from the prior art. These are used, for example, as robotic lawnmowers or as robotic vacuum cleaners. Traditionally, robotic lawnmowers have a cable with a signal buried around the area to be mowed or a fence has been placed around the area to be mowed. Robotic vacuum cleaners are restricted in their movement by walls. Restricting the freedom of movement of a robotic lawnmower or a robotic vacuum cleaner therefore requires an infrastructural boundary, which means that such robots cannot be deployed quickly. It is also disadvantageous that if only part of a terrain may be mowed or a part of a space may be vacuumed, or if a terrain or space changes, the infrastructural boundary must be adapted. There is therefore a need for a flexible solution for limiting the freedom of movement of an unmanned autonomous vehicle and navigating the unmanned autonomous vehicle on the terrain or in the space without the need for an infrastructural boundary.

Such a method is known, for example, from EP 2 884 364.

EP '364 describes a method in which an autonomous gardening vehicle is moved through a terrain, while the vehicle simultaneously takes series of images of sections of the terrain. At least two images of a series comprise identical points in the section of the terrain. Simultaneously with the movement of the autonomous vehicle, an algorithm for locating the autonomous vehicle and for mapping the terrain is executed, generating terrain data from the series of images, the terrain data comprising a scatter plot and relative positions of the autonomous vehicle in the scatter plot. An absolute scale is applied to the scatter plot. The absolute scale is determined by taking a reference image of a reference body of known dimensions, spatial orientation and/or shape and processing the reference image using image processing.

This method has the drawback that, despite the fact that no infrastructural boundary is necessary, putting the autonomous vehicle into service takes a lot of time. The autonomous vehicle must be moved over the entire terrain before a map of the terrain is available and the autonomous vehicle can navigate autonomously effectively. At the same time, relative positions of the autonomous vehicle must be determined in order to be able to use the images effectively for making a map. Good relative positions are indispensable for a good map for navigation, so that the autonomous vehicle is equipped with one or more additional sensors for determining the relative positions in addition to a camera. It is also disadvantageous that a reference image of a reference body is necessary in order to be able to scale the scatter plot absolutely. If the reference body is lost, a new identical reference body must be provided or a new reference body must be defined.

The present invention aims to solve at least some of the above problems or drawbacks.

### SUMMARY OF THE INVENTION

In a first aspect, the present invention relates to a method according to claim 1.

In this method, the unmanned vehicle is first moved along a perimeter in the terrain, capturing a first set of series of images of the terrain. The perimeter determines a defined part of the terrain. Based on the first set of series of images, a map of the perimeter in the terrain is then created. Only then is the map of the perimeter created, which simplifies and speeds up the capture of the first set of series of images of the terrain compared to a method of simultaneously keeping track of relative positions of an unmanned autonomous vehicle and creating a map of the terrain. The map of the perimeter in the terrain is particularly advantageous because it then allows autonomous exploration of the demarcated part of the terrain by the unmanned autonomous vehicle, creating a second set of series of images of the terrain. Using the map of the perimeter in the terrain, the unmanned and autonomous vehicle knows when it is at the perimeter and therefore stays within the demarcated part. It is no longer necessary for a person to move the unmanned autonomous vehicle over the entire terrain themselves, so that commissioning takes less time from the person. After the demarcated part has been explored autonomously by the unmanned autonomous vehicle, a map of the terrain is created on the basis of the first and second sets of series of images. Based on the map of the terrain, the unmanned autonomous vehicle can navigate autonomously within the demarcated part of the terrain, without having to create infrastructural boundaries.

Preferred embodiments of the method are set out in claims 2-13.

A specific preferred form of the invention relates to a method according to claim 2.

In this preferred form, the unmanned autonomous vehicle is moved along the perimeter in the terrain by following a person. The unmanned autonomous vehicle captures the person by means of the camera and the person is recognized in the captured images by the unmanned autonomous vehicle and followed. This is advantageous because moving the unmanned autonomous vehicle requires minimal effort on the part of the person. The perimeter needs to be walked around by the person a single time in order for the unmanned autonomous vehicle to continue exploring the portion of the terrain delineated by the perimeter completely autonomously and then create a map of the terrain. The unmanned autonomous vehicle does not have to be physically moved by the person themselves or controlled with the aid of a control, whether or not remotely.

In a second aspect, the present invention relates to an unmanned autonomous vehicle according to claim 14.

Such an unmanned autonomous vehicle is advantageous because, after minimal effort by a person and without the use of infrastructural boundaries, it is suitable for autonomous exploration of a demarcated part of a terrain, creating a map of the terrain and autonomous navigation within the demarcated part of the terrain. Preferred forms of the unmanned autonomous vehicle are described in dependent claims 15-17.

In a third aspect, the present invention relates to a use according to claim 18. This use results in a simplified commissioning of an unmanned autonomous vehicle for autonomous mowing of a lawn, wherein a person demarcates part of a terrain as the lawn to be mowed with minimal effort and without using infrastructural boundaries, after which the unmanned autonomous vehicle explores the demarcated part of the terrain, after which a map is created and after which the unmanned autonomous vehicle then mows the lawn autonomously. An additional advantage of this use is that only part of a lawn can be delimited as the lawn to be mowed.

### BRIEF DESCRIPTION OF THE FIGURES

FIG. 1 shows a schematic representation of an unmanned autonomous vehicle according to an embodiment of the present invention.

FIG. 2 shows a schematic representation of estimating a distance from an identical point to an unmanned autonomous vehicle and estimating a dimension of an identical point according to an embodiment of the present invention.

FIG. 3 shows a block diagram of a method according to an embodiment of the present invention.

### DETAILED DESCRIPTION

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

The terms “comprise”, “comprising”, “consist of”, “consisting of”, “provided with”, “include”, “including”, “contain”, “containing”, are synonyms and are inclusive or open terms that indicate the presence of what follows, and which do not exclude or prevent the presence of other components, characteristics, elements, members, steps, as known from or disclosed in the prior art.

Quoting numerical intervals by endpoints comprises all integers, fractions and/or real numbers between the endpoints, these endpoints included.

In a first aspect, the invention relates to a method for navigation of an unmanned vehicle in a delimited part of a terrain.

According to a preferred embodiment, the unmanned vehicle comprises a drive unit and a camera for taking images of the terrain.

The drive unit comprises at least one wheel and a motor for driving the wheel. Preferably, the motor is an electric motor. Preferably, the unmanned autonomous vehicle comprises a battery for powering the motor and other electrical systems. It will be apparent to one skilled in the art that the unmanned autonomous vehicle may comprise two, three, four or more wheels, wherein at least one wheel, preferably at least two wheels, are coupled to the motor for driving. It will be apparent to one skilled in the art that the at least one wheel can be part of a caterpillar track, the caterpillar track being drivable by the motor by means of the at least one wheel. The unmanned autonomous vehicle comprises a steering device for steering the unmanned autonomous vehicle. The steering device is a conventional steering device in which at least one wheel is rotatably arranged. Alternatively, the steering device is part of the drive unit, wherein two wheels on opposite sides of the unmanned autonomous vehicle can be driven differently by the motor. Differently means with a different speed and/or opposite direction of rotation. The steering device may or may not be part of the drive unit.

The camera is a digital camera. The camera is at least suitable for taking two-dimensional images. Optionally, the camera is suitable for taking three-dimensional images, with or without depth determination. The camera has a known viewing angle. The camera has a known position and alignment on the unmanned autonomous vehicle. Knowing the viewing angle of the camera and the position and the alignment of the camera on the unmanned autonomous vehicle, it is possible by means of trigonometry and/or photogrammetry to automatically estimate a distance from an object in an image to the camera and the unmanned autonomous vehicle, a distance between two objects in an image and/or a dimension of an object in an image, even if the camera is only suitable for taking two-dimensional images. The camera has a fixed position and alignment on the unmanned autonomous vehicle. Alternatively, the camera is rotatably arranged, the camera being 360° rotatable in a horizontal plane and 180° rotatable in a vertical plane. The rotatable arrangement of the camera is preferably drivably coupled to motors with encoders. Motors with encoders are advantageous for knowing the position and alignment of a rotatably mounted camera.

The method comprises the steps of:
Moving the unmanned vehicle on the terrain. The terrain can be indoors, for example a factory hall or a function room, or outdoors, for example a garden, a soccer field, or a square. The camera simultaneously captures series of images of the terrain. At least two images of a series comprise a number of identical points in the terrain. This number is at least one. Non-limiting examples of identical points are a tree, a fence, a wall, a post, a path, etc. It will be apparent to one skilled in the art that an identical point can also be part of a tree, a fence, a wall, or the like. Preferably, any two consecutively captured images of a series of images comprise a number of equal identical points. A first series of images represents a first part of the terrain visible to the camera of the unmanned autonomous vehicle at the time of capturing the images. A second series of images represents a second part of the terrain. The second series may, but need not, have identical points in common with the first series. For example, a second series of images is captured after the unmanned vehicle turns in a different direction, making a second part of the terrain visible to the camera of the unmanned autonomous vehicle. The images are captured at an adapted rate, expressed in frames per second, so that at least two images of a series comprise a number of identical points in the terrain, preferably at least two consecutive images of a series comprise a number of identical points in the terrain. It will be apparent to a person skilled in the art that the speed of capturing images of a series of images is dependent on a speed at which the unmanned autonomous vehicle is moved on the terrain.
Creating a map of the terrain based on the series of images of the terrain. The map of the terrain is created after capturing series of images. As a result, the autonomous vehicle does not have to simultaneously capture series of images and map a terrain, whereby an unmanned autonomous vehicle requires limited computing power and whereby the capture of series of images is sped up and simplified. The series of images are automatically processed by image processing, wherein identical points comprised in multiple images are identified. Identical points are identified by looking for equal or similar pixels in the series of images. Pixels are, for example, equal or equivalent if they are part of the same contour of, for example, a tree, wall, or fence. The contours in the captured images are preferably determined using an edge detection algorithm. Non-limiting examples are a Canny algorithm and a Sobel operator. Equal or equivalent pixels preferably have a pixel value that differs from each other by at most a predetermined value. Preferably, eight neighboring pixels of the equal or equivalent pixels, located on a square perimeter around said equal or equivalent pixels, also differ from each other by no more than a predetermined value. An identical point is identified if at least 50 equal or similar pixels are found in at least two images, preferably at least 100 equal or similar pixels, more preferably at least 150 equal or similar pixels and even more preferably at least 200 equal or similar pixels. By means of trigonometry and/or photogrammetry, distances from identical points in an image to the camera and the unmanned autonomous vehicle, distances between two identical points in the same image and/or dimensions of identical points in an image are estimated automatically. These estimates are not necessarily precise and may include errors. By frequently estimating distances between identical points and dimensions of identical points based on multiple images, preferably in multiple series of images, the errors in the estimates are averaged out and a map of the terrain can be created in which positions of the identical points relative to each other are determined. Due to the frequent estimation of distances and dimensions, the map is automatically absolutely scaled, without using a reference body with known dimensions, spatial orientation and/or shape. Optionally, additional information for absolute scaling can be used, such as estimates of distances from the unmanned autonomous vehicle to identical points in a three-dimensional image based on depth determinations in the three-dimensional image, or a distance measurement from the unmanned autonomous vehicle to an identical point in an image by means of lasers, ultrasound transceivers, radars or other suitable means contained in the unmanned autonomous vehicle, the distance measurement being stored together with the image.
Autonomous navigation of the unmanned autonomous vehicle in a delimited part of the terrain based on the created map of the terrain. While navigating, the unmanned autonomous vehicle captures images of the terrain with the help of the camera and, using image recognition, identifies identical points that are included in the created map of the terrain. The created map of the terrain is preferably stored in the unmanned autonomous vehicle. By means of trigonometry and/or photogrammetry, distances between identified identical points in a captured image and the camera and the unmanned autonomous vehicle are estimated and based on the estimated distances between the identified identical points and the created map of the terrain, a position of the unmanned autonomous vehicle in the demarcated part of the terrain is determined. Preferably, at least a part of successively determined positions of the unmanned autonomous vehicle are at least temporarily stored by the unmanned autonomous vehicle. Preferably, at least the last ten consecutively determined positions are stored at least temporarily, more preferably at least twenty, even more preferably at least thirty and even more preferably at least fifty. Storing successively determined positions at least temporarily is advantageous for an accurate determination of a position of the unmanned autonomous vehicle in the demarcated part of the terrain, because an incorrect estimate of one or more distances to identical points can be detected because, for example, this can lead to an impossible change in position of the unmanned vehicle compared to the saved last successively determined positions. The unmanned vehicle can navigate autonomously in the demarcated part of the terrain according to a random pattern or a fixed pattern. Preferably, the unmanned autonomous vehicle carries out a task during autonomous navigation in the demarcated part of the terrain, such as mowing a lawn, sweeping a square, vacuuming a room, autonomously transporting goods in a factory hall or on a company site, etc.

In this preferred embodiment of the method, the unmanned vehicle is first moved along a perimeter in the terrain. The perimeter determines a defined part of the terrain. The perimeter can be completely within the terrain, for example a part in the middle of a meadow, wholly on an outer perimeter of the terrain, for example an outer perimeter of the meadow delimited by a fence, or partly inside and partly on the outer perimeter of the terrain, for example part of a meadow that adjoins part of the fence. The perimeter is not necessarily along or following an infrastructural boundary, such as a fence or a wire. As the unmanned vehicle moves along the perimeter, a first set of series of images of the terrain is captured. During the movement of the unmanned vehicle along the perimeter, no localization of the unmanned and autonomous vehicle is done, whereby an unmanned autonomous vehicle requires limited computing power and whereby the capture of the first set of series of images is sped up and simplified. The series of images are as previously described. This first set of series of images represents the perimeter of the demarcated part of the terrain. Based on the first set of images, a map of the perimeter in the terrain is created. The map is created after capturing the first set of images in a similar way as previously described, meaning that an unmanned autonomous vehicle requires limited computing power to create the map of the perimeter in the terrain. The created map of the perimeter in the terrain mainly comprises identical points on the perimeter and identical points visible to the camera from the perimeter. The map created automatically comprises an indication of the perimeter of the demarcated part of the terrain.

The creation of the map of the perimeter is followed by the autonomous exploration of the demarcated part of the terrain based on the created map of the perimeter in the terrain. The unmanned autonomous vehicle moves autonomously on the terrain in a random or fixed pattern. During exploration, a second set of series of images of the terrain is captured. Simultaneously with the capture of the second set of series of images, the unmanned autonomous vehicle identifies identical points included in the created map of the perimeter in the terrain. The created map of the perimeter is preferably stored in the unmanned autonomous vehicle. By means of trigonometry and/or photogrammetry, distances from identified identical points in a captured image to the camera and the unmanned autonomous vehicle are estimated and based on the estimated distances and the created map of the perimeter in the terrain, a position of the unmanned autonomous vehicle relative to the perimeter in the terrain is determined. This is advantageous because it allows the unmanned autonomous vehicle to autonomously detect that the perimeter of the demarcated part of the terrain has been reached, after which the unmanned autonomous vehicle moves away from the perimeter and remains within the demarcated part of the terrain. As a result, it is not necessary for a person to themselves move the unmanned autonomous vehicle over the entire demarcated part of a terrain, so that putting the unmanned autonomous vehicle into service requires less time from the person. The localization of the unmanned autonomous vehicle is a limited localization by means of a limited map of the perimeter in the terrain, whereby an unmanned autonomous vehicle requires limited computing power and whereby the capture of the second set of series of images is sped up and simplified.

After exploring the demarcated part of the terrain, the map of the terrain is created on the basis of the first and second sets of series of images. This is the step from the method described previously.

This embodiment is advantageous for autonomously navigating an unmanned autonomous vehicle within a demarcated part of a terrain, wherein commissioning of the unmanned autonomous vehicle can take place quickly and efficiently and wherein a part of the terrain can be demarcated without the need for infrastructural boundaries. This embodiment is particularly advantageous for demarcating, for example, a part of, for example, a continuous lawn, a part of an open square or a part of a large hall, without introducing infrastructural boundaries.

According to one embodiment, the unmanned autonomous vehicle is pulled or pushed by a person while moving along the perimeter in the terrain. This embodiment is advantageous because the unmanned autonomous vehicle need have only minimal facilities to be moved along the perimeter.

According to one embodiment, the unmanned autonomous vehicle is moved by a person with the aid of a control while moving along the perimeter in the terrain. The control is preferably a remote control. The remote control is wired or wireless. The remote control is preferably wireless. This embodiment is advantageous because a person does not have to make strenuous physical efforts such as pulling or pushing the unmanned autonomous vehicle.

According to a preferred embodiment, the unmanned autonomous vehicle is moved along the perimeter in the terrain by following a person. The unmanned autonomous vehicle uses the camera to record images of the person. The person is recognized and followed by the unmanned vehicle using image recognition in the captured images. The unmanned autonomous vehicle uses the drive unit and steering device to keep the person visible to the camera and at an equal distance.

Preferably, the unmanned autonomous vehicle is configured to keep the person at a distance of at least 1 m and at most 5 m. Preferably, the unmanned autonomous vehicle is configured to keep the person at a distance of at least 1.5 m, more preferably at least 2 m and even more preferably at least 2.5 m. Preferably, the unmanned autonomous vehicle is configured to hold the person at a distance of at most 4 m, more preferably at most 3.5 m and even more preferably at most 3.25 m. Within these distances, a person is far enough away from the camera that the camera has a sufficient view of the terrain and the series of images of the terrain can be used to create a map of the perimeter in the terrain. On the other hand, the person is close enough to the camera so that the person can easily and successfully be recognized and followed by the unmanned autonomous vehicle.

This embodiment is advantageous because moving the unmanned autonomous vehicle requires minimal effort on the part of the person. The perimeter needs to be walked around by the person a single time in order for the unmanned autonomous vehicle to continue exploring the portion of the terrain delineated by the perimeter completely autonomously and then create a map of the terrain. The unmanned autonomous vehicle does not have to be physically moved by the person themselves or controlled with the aid of a control, whether or not remotely. Driving an unmanned autonomous vehicle with a control requires a large learning curve, while after creating the map of the terrain, manually operating the unmanned autonomous vehicle is no longer necessary.

It will be apparent to one skilled in the art that an unmanned autonomous vehicle may be suitable for being moved along the perimeter in the terrain according to any of the previously described embodiments.

According to a preferred embodiment, during the capture of the first set of series of images, only one series of images is captured. Simultaneously with the capturing of said series of images, identical points are identified in every two consecutive images. If at least one identical point between two consecutive images cannot be identified, a signal is generated and/or the capture of the first set of series of images is stopped. This embodiment is advantageous because with one series of images, in which at least one identical point can be identified between every two consecutive images, a map of the perimeter in the terrain can be guaranteed to be created. As a result, there is no risk that the unmanned autonomous vehicle has to be moved again along the terrain because the creation of the map of the perimeter in the terrain fails. This can happen, for example, if the camera of the unmanned autonomous vehicle has been covered and the camera only has a clear field of view again at a different position along the perimeter in the terrain, as a result of which it may no longer be possible to identify identical points that correspond to identical points in previously captured images and no map of a closed perimeter in the terrain can be created.

According to one embodiment, the first and second sets of series of images are stored by the unmanned autonomous vehicle on a server via a data connection, preferably a wireless data connection. The first and second sets of series of images are processed in the server for the creation of the map of the perimeter in the terrain and for the creation of the map of the terrain. The server is either a local server or a server in the cloud. The wireless data connection is a Wi-Fi connection or a data connection over a mobile network, such as 5G.

This embodiment is advantageous because a server has sufficient storage and computing power to store and process the first and second sets of series of images.

According to a preferred embodiment, the first and second sets of series of images are stored in the unmanned autonomous vehicle. To this end, the unmanned autonomous vehicle comprises a memory, preferably a non-volatile memory. The first and the second sets of series of images are processed in the unmanned autonomous vehicle for the creation of the map of the perimeter in the terrain and for the creation of the map of the terrain. To this end, the unmanned autonomous vehicle comprises a primary storage (working memory) and a processor. Because the first and second sets of series of images are only processed after moving the unmanned autonomous vehicle along the perimeter in the terrain and after the autonomous exploration of the demarcated part of the terrain, limited computing power is still required in the unmanned autonomous vehicle.

This embodiment is advantageous because series of images can be captured and saved and processed for the creation of the map of the perimeter in the terrain and the map of the terrain even if the unmanned autonomous vehicle has no data connection. Sending the first and the second sets of series of images over a data connection, in particular a data connection over a mobile network, can require a lot of data depending on the size of the terrain and can be expensive depending on the type of subscription.

According to a further embodiment, the first and second sets of series of images are processed in the unmanned vehicle while the unmanned vehicle is being charged at a charging station. The unmanned autonomous vehicle is connected to the charging station by means of an electrical cable or electrical contacts. Alternatively, the unmanned autonomous vehicle is wirelessly charged by the charging station. Processing the first and second sets of series of images is a computationally intensive task that requires a lot of power. By processing the first and second sets of series of images while the unmanned autonomous vehicle is being charged, it is avoided that during processing, for example, the battery of the unmanned autonomous vehicle reaches a critical level or is depleted, resulting in premature termination of processing and possibly intermediate results, an already created map of the perimeter in the terrain and/or series of images are lost.

According to a preferred embodiment, the map of the terrain is absolutely scaled, the absolute scaling being done only on the basis of estimation of dimensions and/or distances from and/or between identical points in at least two images. This is advantageous because as a result the camera of the unmanned autonomous vehicle only needs to be suitable for taking two-dimensional images. The camera does not have to be suitable for taking three-dimensional images. The camera does not have to be suitable for depth determination. Preferably, only one camera for two-dimensional images is mounted on the unmanned autonomous vehicle. Preferably, the camera is fixedly mounted on the vehicle. Preferably, the unmanned vehicle does not include lasers, ultrasound transceivers, radars, or other suitable means for measuring distances from the unmanned autonomous vehicle to an object on the terrain.

This embodiment is particularly advantageous because it allows a very simple unmanned autonomous vehicle to be used for navigation in a demarcated part of a terrain.

According to a preferred embodiment, the unmanned autonomous vehicle comprises a sensor for measuring a number of revolutions of the at least one wheel of the unmanned autonomous vehicle. The measured number of revolutions is used as a filter for estimates of dimensions and/or distances from and/or between identical points in two images. For this purpose, the measured number of revolutions of a wheel between the capturing of two consecutive images is stored together with the last captured image. The number of revolutions is a measure of a distance traveled by the unmanned autonomous vehicle between the capturing of two consecutive images. It will be apparent to one skilled in the art that by adding up the stored numbers of revolutions of consecutive images, a measure is obtained for the distance traveled by the unmanned autonomous vehicle between a first image and a last image of the consecutive images. For example, if an estimate of dimensions and/or distances from and/or between identical points in two images is a factor greater or less than what can be expected based on a distance traveled by the unmanned autonomous vehicle between taking the two images, then this is an indication that the estimate of dimensions and/or distances from and/or between identical points is erroneous. The estimate is not used further in this case. To determine which estimate of dimensions and/or distances from and/or between identical points is likely to be erroneous, i.e. based on a first or based on a second of two images, the estimates are compared with an average of already available estimates of the said dimensions and/or distances from and/or between identical points. The estimate that deviates the most from the said average is considered to be the erroneous estimate.

The number of revolutions is a measure of the distance traveled but is not necessarily accurate due to possible slippage of the at least one wheel. In addition, it is possible that the unmanned autonomous vehicle changes direction during the capture of series of images. For this purpose, the number of revolutions of the at least one wheel is used as a filter for estimates of dimensions and/or distances from and/or between identical points in two images, with a maximum of 10 intermediate images captured between the first and second of the two images, preferably at most 8, more preferably at most 6, even more preferably at most 4 and even more preferably at most 2.

This embodiment is advantageous for increasing the accuracy of the created map of the perimeter of the perimeter in the terrain and/or the accuracy of the created map of the terrain.

In a preferred embodiment, exploring the demarcated part of the terrain follows a pattern of progressively smaller loops within the perimeter. Each loop is followed both clockwise and counterclockwise. Preferably, a loop has a shape similar to the shape of the perimeter of the demarcated part of the terrain. Preferably, a next smaller loop is located at a distance of at least 1 m and at most 5 m within a previous larger loop. More preferably, a next smaller loop is located at a distance of at least 2 m within a previous larger loop, even more preferably at a distance of at least 2.5 m. More preferably, a next smaller loop is located at a distance of at most 4 m within a previous larger loop, even more preferably at a distance of at most 3.5 m. This embodiment is advantageous because it allows a faster autonomous exploration by the unmanned autonomous vehicle of the demarcated part of the terrain compared to a random pattern, while capturing a sufficiently large second set of series of second images to create a map of the terrain. Because the loops are followed both clockwise and counterclockwise, it can be ensured that identical points are captured in series of images from multiple points of view. This is particularly advantageous in combination with a previously described embodiment wherein the map of the terrain is absolutely scaled, the absolute scaling being done only on the basis of estimation of dimensions and/or distances from and/or between identical points in at least two images. By frequently estimating distances between identical points based on multiple images, preferably in multiple series of images, the errors in the estimates are averaged out.

According to a preferred embodiment, the unmanned autonomous vehicle recognizes a ground type by means of image recognition. A ground type can be, for example, a lawn, a concrete path, a tiled floor, etc. The unmanned autonomous vehicle compares the recognized ground type with a predetermined ground type. For example, in an unmanned autonomous vehicle for mowing, a lawn may be the predetermined ground type. In an unmanned autonomous vehicle for sweeping a square, clinkers may be the predetermined ground type. If, when moving the unmanned autonomous vehicle along the perimeter in the terrain while capturing the first set of series of images of the terrain, a ground type different from the predefined ground type is recognized at a location in the terrain, a perimeter of a second demarcated part of the terrain is automatically determined. For example, if an unmanned autonomous vehicle for mowing suddenly recognizes a concrete path as ground type when moving along the perimeter in the terrain, because a concrete path crosses the lawn, the perimeter will automatically demarcate two demarcated parts of the terrain, namely a first part of the lawn on a first side of the concrete path and a second part on a second opposite side of the concrete path. For example, if an unmanned autonomous vehicle for sweeping a square suddenly recognizes an asphalt strip as ground type when moving along the perimeter in the terrain, because a bicycle path crosses the square, the perimeter will automatically demarcate two demarcated parts of the terrain, namely a first part of the square on a first side of the bicycle path and a second part on a second opposite side of the bicycle path.

Preferably, as the unmanned autonomous vehicle moves along the perimeter in the terrain, a separate closed perimeter for the first and second demarcated parts of the terrain is formed. For example, when moving the unmanned autonomous vehicle along the perimeter of a lawn, the first and second sides of the concrete path are followed, and the concrete path is crossed at the same point. This is advantageous for creating a map of the perimeter in the terrain, wherein two demarcated parts of the terrain are defined.

Alternatively, as the unmanned autonomous vehicle moves along the perimeter in the terrain, a shared, closed perimeter for the first and second demarcated parts of the terrain is formed. For example, when moving the unmanned vehicle along the perimeter of a lawn, the concrete path is crossed at two different points. The shared perimeter is thus formed by an open perimeter of the first demarcated part of the terrain and by an open perimeter of the second demarcated part of the terrain. Upon autonomous exploration by the unmanned autonomous vehicle in the demarcated part of the terrain, the concrete path is recognized as different from the predetermined ground type, lawn, and is recognized as part of the perimeter of the first demarcated part and as part of the perimeter of the second demarcated part of the terrain, thus obtaining a closed perimeter for the first demarcated part of the terrain and a closed perimeter for the second demarcated part of the terrain. This is advantageous for easily defining a perimeter of a first and a second demarcated part of a terrain, because only a shared perimeter and no perimeter between both parts of the terrain has to be determined.

It will be apparent to one skilled in the art that by moving an unmanned autonomous vehicle along the perimeter in the terrain, a perimeter of one, two or more demarcated parts of the terrain can be automatically determined.

According to a further embodiment, the location in the terrain where a ground type different from the predetermined ground type has been recognized forms a passage for the unmanned autonomous vehicle to the second demarcated part of the terrain during autonomous navigation within the demarcated part of the terrain. Referring to examples in a previously described embodiment, for example, the point where during the movement of the unmanned autonomous vehicle along the perimeter in the terrain the concrete path was crossed is a passage from the first demarcated part of the lawn to the second demarcated part of the lawn and back. This is advantageous because when a person moves the unmanned autonomous vehicle along the perimeter, the person can choose a point for crossing the concrete path where this is practical, for example where the concrete path is level with the lawn, or where it is safe to do so, for example because there are no bushes that obstruct visibility, which may cause users of the concrete path to be surprised by an unmanned autonomous vehicle crossing. A similar example can be given for an unmanned autonomous vehicle that moves from a first demarcated part in a factory hall to a second demarcated part in a factory hall, thereby crossing a pedestrian walkway in a specifically designated strip, for example hatches on a floor surface. The hatches are recognized by the unmanned autonomous vehicle as a ground type that deviates from the predetermined ground type, a gray factory floor, and will only cross the walkway there, limiting the danger for people on the walkway to this hatched strip.

The unmanned autonomous vehicle may or may not continue to carry out its task in the passage. For example, mowing when passing over a concrete path or sweeping when crossing a bicycle path may be temporarily interrupted, but a transport task will continue to be carried out.

According to one embodiment, the unmanned autonomous vehicle automatically avoids objects and/or obstacles within the demarcated part of the terrain. The objects and/or obstacles are identified on the basis of image recognition. An obstacle can also be a ground type that differs from the predetermined ground type. The objects and/or obstacles can, but do not have to be part of the created map of the perimeter in the terrain or the created map of the terrain. Non-exhaustive examples are animals such as hedgehogs, people, fences, flowerbeds, shoes, water features, etc. This embodiment is advantageous because a created map does not necessarily have to be adapted if a terrain changes, for example laying a flower bed in a lawn or placing a fence, because animals and persons are protected against collision by the unmanned autonomous vehicle and because when determining the perimeter in the terrain it is not necessary to define additional internal perimeters within the demarcated part of the terrain, for example to avoid water features and flower beds in a lawn or to avoid machines in a factory hall.

According to a further embodiment, the unmanned autonomous vehicle dynamically adjusts the map of the terrain based on identified objects and/or obstacles. The identified objects and/or obstacles are automatically added to the map of the terrain. Adjustment of the map is done automatically without the intervention of a user of the unmanned autonomous vehicle. A user does not have to add the identified objects and/or obstacles to the map or initiate an action to modify the created map. As previously described, an obstacle can be a ground type, which differs from a predetermined ground type. The obstacle may also be a ground type, which deviates from predetermined ground types and/or with ground types on the perimeter as described in a later embodiment about exceeding the perimeter while autonomously exploring the demarcated part of the terrain. This embodiment is advantageous because, for example, after the creation of a flower bed in a lawn, whether or not at the edge of the lawn, the map created is automatically adapted and so that the unmanned autonomous vehicle when performing a task within the demarcated part of the terrain can take into account the adapted map. This is particularly advantageous in combination with an embodiment described below, wherein the unmanned autonomous vehicle follows a pattern of adjacent lines or concentric loops during autonomous navigation in the demarcated part of the terrain, because the unmanned autonomous vehicle can automatically adapt the pattern of adjacent lines or concentric loops to a changed situation within the demarcated part of the terrain. This embodiment is also advantageous in case mobile objects and/or obstacles, such as for instance a ball or a hedgehog, have been identified. These mobile objects and/or obstacles are preferably also automatically added to the created map. As a result, when approaching a last known position of a mobile object and/or obstacle, the unmanned autonomous vehicle can, for example, slow down in order to avoid a collision with the mobile object and/or obstacle. Preferably, identified objects and/or obstacles are also automatically removed from the created map if a previously identified object and/or obstacle is no longer present, for instance because a hedgehog has disappeared, a ball has been removed or a flowerbed has been sown as a lawn.

According to a preferred embodiment, during the autonomous exploration of the demarcated part of the terrain, the unmanned autonomous vehicle exceeds the perimeter at most by a predetermined distance. The predetermined distance is measured as the shortest distance to a nearest point of the perimeter. The demarcated part of the terrain is thus bounded by a line outside the perimeter, parallel to the perimeter and at a distance equal to the predetermined distance from the perimeter.

This embodiment is advantageous in cases where it is not possible to move the unmanned autonomous vehicle exactly along a boundary of the demarcated part of the terrain. For example, the boundary of the demarcated part of the terrain runs along a drop, along a wall or along a side of a swimming pool, so that there is a real risk that the unmanned autonomous vehicle when moving along the boundary, falls down the drop or into the swimming pool or rubs against the wall and is damaged. By moving the unmanned autonomous vehicle along a perimeter at a distance from the boundary of the demarcated part of the terrain and within the demarcated part of the terrain, this risk is avoided.

This embodiment is particularly advantageous in combination with a previously described embodiment wherein the unmanned autonomous vehicle automatically avoids objects and/or obstacles within the demarcated part of the terrain. When exceeding the perimeter during autonomous exploration, the unmanned autonomous vehicle will automatically avoid the drop, swimming pool and wall from the previous examples, so the perimeter does not have to be an exact distance from these obstacles. It is sufficient that the perimeter is at a distance less than the predetermined distance from the obstacles.

The predetermined maximum distance is preferably at most 100 m, more preferably at most 60 m, even more preferably at most 30 m, even more preferably at most 9 m, even more preferably at most 3 m, still even more preferably at most 2 m and most preferably at most 1 m.

According to a further embodiment, the unmanned autonomous vehicle recognizes ground types outside the perimeter by means of image recognition when exceeding the perimeter while autonomously exploring the demarcated part of the terrain. Examples of ground types were given in a previously described embodiment. The unmanned autonomous vehicle compares recognized ground types with predetermined ground types and/or with ground types on the perimeter. Ground types on the perimeter are preferably determined automatically as the unmanned autonomous vehicle moves along the perimeter. If a recognized ground type does not match a predetermined ground type and/or a ground type on the perimeter, the unmanned autonomous vehicle will not further exceed the perimeter even if the predetermined distance has not yet been reached. This means that the unmanned autonomous vehicle explores a demarcated part of the terrain that is at most the predefined distance outside the perimeter and that parts of the demarcated part of the terrain have a ground type that corresponds to predetermined ground type and/or ground types on the perimeter.

This embodiment is advantageous because it means that it is not always necessary to move exactly along a boundary of the demarcated part of the terrain when moving the unmanned autonomous vehicle, so that the perimeter can be determined much more quickly. It is sufficient in this embodiment to move the unmanned autonomous vehicle along a perimeter which lies within the demarcated part of the terrain and at most the predetermined distance from the boundary. For example, a lawn could be completely bordered by flowerbeds and a patio. By moving the unmanned autonomous vehicle at a distance of, for example, at most 3 m from an edge of the lawn, a perimeter is defined within the lawn. The unmanned autonomous vehicle will then exceed the perimeter when autonomously exploring the demarcated area, as long as grass is recognized as the ground type. The flower beds and the patio are not part of the demarcated part of the terrain. If the predetermined distance for exceeding the perimeter is 3 m or more, the unmanned autonomous vehicle will autonomously explore the entire lawn and the demarcated part of the terrain will be the entire lawn. If the predetermined distance is less than 3 m, for example 1 m, it is possible that parts of the lawn do not belong to the demarcated part of the terrain, if the perimeter there is further than 1 m from the edge of the lawn.

According to a preferred embodiment, the unmanned autonomous vehicle follows a pattern of adjacent lines or concentric loops during autonomous navigation in the demarcated part of the terrain. This is particularly advantageous in order to be able to efficiently perform a task in a demarcated part of the terrain, such as, for example, mowing a lawn, sweeping a square or cleaning a factory hall. With a random pattern, the same point within the demarcated part of the terrain can be mowed, swept, or cleaned several times before the entire demarcated part of the terrain is finished.

According to a preferred embodiment, a person indicates on the map of the terrain parts of the perimeter, the unmanned autonomous vehicle navigating within the perimeter and on said parts of the perimeter during autonomous navigation. The person indicates the relevant parts of the perimeter on the map of the terrain in a graphical interface on, for example, a smartphone, a tablet or on a computer. The input of the person is sent to the unmanned autonomous vehicle via a data connection. This embodiment is particularly advantageous in combination with an unmanned autonomous vehicle for mowing a lawn. During autonomous navigation, the unmanned autonomous vehicle mows within the perimeter, the demarcated part of the terrain, but also mows on the aforementioned parts of the perimeter, for example on a transition between a lawn and a concrete path. This embodiment is advantageous because it avoids that a longer strip of grass remains next to the concrete path after mowing a lawn, because the unmanned autonomous vehicle navigates within the perimeter and thus along the concrete path, which must subsequently be mowed manually or with the aid of another implement. It will be apparent to one skilled in the art that this embodiment is also suitable for other applications, such as sweeping, for example, a bicycle path, wherein the edge of a bicycle path is also swept.

According to one embodiment, a pattern is drawn on the map of the terrain by a person. The person draws the pattern on the map of the terrain in a graphical interface on, for example, a smartphone, a tablet or on a computer. A pattern can be a line, loop, polygon, or free form, filled or unfilled. The person also indicates which action or actions are to be performed by the unmanned autonomous vehicle at locations lying on the pattern. For example, the unmanned vehicle should mow the locations on the pattern shorter, longer, or not at all. The input of the person is sent to the unmanned autonomous vehicle via a data connection. This embodiment is advantageous to have the unmanned autonomous vehicle perform, temporarily or otherwise, other, or additional actions at locations on the pattern within the demarcated part of the terrain, such as for instance mowing patterns in a lawn.

According to one embodiment, the unmanned autonomous vehicle patrols the demarcated part of the terrain. Preferably, the unmanned autonomous vehicle captures images of the terrain. Preferably, the unmanned autonomous vehicle only captures images of the terrain when a person or animal is detected in the demarcated part of the terrain. Preferably, a date and time is stated on a captured image.

According to one embodiment, the unmanned autonomous vehicle captures images of predetermined points of the terrain at regular intervals during autonomous navigation in the demarcated part of the terrain. These captured images form a series of images through time of a fixed location. These images are advantageous for monitoring, for example, the growth of a flower bed, the status of a lawn or the cleanliness of a square or factory hall.

In a second aspect, the invention relates to an unmanned autonomous vehicle for navigation in a demarcated part of a terrain.

According to a preferred embodiment, the unmanned vehicle comprises a drive unit and a camera for taking images of the terrain.

The drive unit comprises at least one wheel and a motor for driving the wheel. Preferably, the motor is an electric motor. Preferably, the unmanned autonomous vehicle comprises a battery for powering the motor and other electrical systems. It will be apparent to one skilled in the art that the unmanned autonomous vehicle may comprise two, three, four or more wheels, wherein at least one wheel, preferably at least two wheels, are coupled to the motor for driving. It will be apparent to one skilled in the art that the at least one wheel can be part of a caterpillar track, the caterpillar track being drivable by the motor by means of the at least one wheel. The unmanned autonomous vehicle comprises a steering device for steering the unmanned autonomous vehicle. The steering device is a conventional steering device in which at least one wheel is rotatably arranged. Alternatively, the steering device is part of the drive unit, wherein two wheels on opposite sides of the unmanned autonomous vehicle can be driven differently by the motor. Differently means with a different speed and/or opposite direction of rotation.

The camera is a digital camera. The camera is at least suitable for taking two-dimensional images. Optionally, the camera is suitable for taking three-dimensional images, with or without depth determination. The camera has a known viewing angle. The camera has a known position and alignment on the unmanned autonomous vehicle. Knowing the viewing angle of the camera and the position and the alignment of the camera on the unmanned autonomous vehicle, it is possible by means of trigonometry and/or photogrammetry to automatically estimate a distance from an object in an image to the camera and the unmanned autonomous vehicle, a distance between two objects in an image and/or a dimension of an object in an image, even if the camera is only suitable for taking two-dimensional images. The camera has a fixed position and alignment on the unmanned autonomous vehicle. Alternatively, the camera is rotatably arranged, the camera being 360° rotatable in a horizontal plane and 180° rotatable in a vertical plane. The rotatable arrangement of the camera is preferably drivably coupled to motors with encoders. Motors with encoders are advantageous for knowing the position and alignment of a rotatably mounted camera.

The unmanned autonomous vehicle comprises a memory and a processor. The processor is configured to perform a method according to the first aspect. The memory preferably comprises both a primary storage (working memory) and a non-volatile memory.

Such an unmanned autonomous vehicle is advantageous because, after minimal effort by a person and without the use of infrastructural boundaries, it is suitable for autonomous exploration of a demarcated part of a terrain, creating a map of the terrain and autonomous navigation within the demarcated part of the terrain.

According to a preferred embodiment, the camera of the unmanned vehicle is only suitable for taking two-dimensional images. Preferably, only one camera for two-dimensional images is mounted on the unmanned autonomous vehicle. Preferably, the unmanned vehicle does not include lasers, ultrasound transceivers, radars, or other suitable means for measuring distances from the unmanned autonomous vehicle to an object on the terrain.

This embodiment is particularly advantageous because it provides a very simple unmanned autonomous vehicle for navigation in a demarcated part of a terrain.

According to a preferred embodiment, the unmanned autonomous vehicle comprises a sensor for measuring a number of revolutions of the at least one wheel of the unmanned autonomous vehicle. A measured number of revolutions is a measure of a distance traveled by the unmanned autonomous vehicle, whereby as previously described the measured number of revolutions can be used as a filter for estimates of dimensions and/or distances from and/or between identical points in two images.

According to a preferred embodiment, the camera has a fixed position on the unmanned autonomous vehicle. This is advantageous because without using additional sensors or storing additional information, it is always known how identical points in an image are positioned relative to the camera and the unmanned autonomous vehicle, resulting in a simpler unmanned autonomous vehicle.

In a third aspect, the invention relates to a use of a method according to the first aspect or an unmanned autonomous vehicle according to the second aspect for autonomous mowing of a lawn.

This use results in a simplified commissioning of an unmanned autonomous vehicle for autonomous mowing of a lawn, wherein a person demarcates at least a part of a terrain as the lawn to be mowed with minimal effort and without using infrastructural boundaries, after which the unmanned autonomous vehicle explores the demarcated part of the terrain, after which a map is created and after which the unmanned autonomous vehicle then mows the lawn autonomously. An additional advantage of this use is that only part of a lawn can be delimited as the lawn to be mowed. One skilled in the art will appreciate that a method according to the first aspect is preferably performed with an unmanned autonomous vehicle according to the second aspect and that an unmanned autonomous vehicle according to the second aspect is preferably configured for performing a method according to the first aspect. Each feature described in this document, both above and below, can therefore relate to any of the three aspects of the present invention.

In what follows, the invention is described by way of non-limiting figures illustrating the invention, and which are not intended to and should not be interpreted as limiting the scope of the invention.

### DETAILED DESCRIPTION OF THE FIGURES

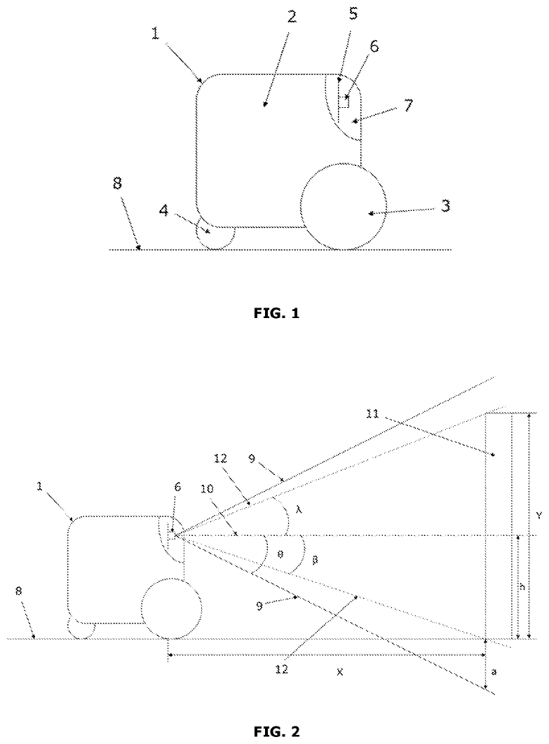

FIG. 1 shows a schematic representation of an unmanned autonomous vehicle according to an embodiment of the present invention.

Said unmanned autonomous vehicle (1) comprises a housing (2). The housing (2) comprises a battery for powering a motor of a drive unit and for powering other electrical and electronic components, including a processor board (5). The processor board (5) comprises a processor, primary storage (working memory) and a camera (6). Preferably, the unmanned autonomous vehicle (1) also comprises non-volatile memory. The camera (6) has a fixed position and alignment on the unmanned autonomous vehicle (1). The camera (1) is suitable for taking two-dimensional images with a resolution of 4K. The camera is placed behind a semi-transparent lens (7). It will be apparent to one skilled in the art that the semi-transparent lens (7) can also be completely transparent. The unmanned autonomous vehicle (1) has a drive unit comprising a motor, not visible in the figure, and two wheels (3) located on opposite sides of the housing (2). Both wheels (3) are drivably connected to the motor. The unmanned autonomous vehicle (1) further comprises a steering device (4). The steering device (4) is a swiveling wheel at the rear of the housing (2). The unmanned vehicle (1) is suitable for driving over a ground surface (8).

FIG. 2 shows a schematic representation of estimating a distance from an identical point to an unmanned autonomous vehicle and estimating a dimension of an identical point according to an embodiment of the present invention.

The unmanned autonomous vehicle (1) is the same as the unmanned autonomous vehicle (1) from FIG. 1. The camera (6) has a known viewing angle. The viewing angle in the vertical direction of the camera (6) is indicated in FIG. 2 by the lines (9). The vertical viewing angle of the camera (6) is equal to 2 times the angle (θ).

The identical point recognized in at least two images of a series of images is a wall (11). The wall (11) is projected onto a sensor of the camera (6). The sensor of the camera (6) has a known number of lines and pixels on a line. For a camera with 4K resolution, this is 2160 lines with 3840 pixels each. The lines (12) define the extreme points of the wall (11) according to vertical direction projected on the sensor of the camera (6).

The camera (6) is mounted on the unmanned autonomous vehicle (1) with a horizontal viewing direction (10) at a known height (h) relative to the ground surface (8). Objects at a height (h) above the ground surface (8), i.e. on the line of the horizontal viewing direction (10), are projected along the vertical direction in the center of the sensor of the camera (6). Using image recognition, it can be determined from a captured image where the wall (11) touches the ground surface (8). This is the point where the bottom line (12) intersects the ground surface (8). A part of the ground surface (8) will be visible on a captured image. This is the part of the ground surface (8) between intersections of the ground surface (8) with the bottom line (9) and the bottom line (12). Said part of the ground surface (8) will comprise a number of lines proportional to the height (a) on a captured image. The part of the wall (11) below the line (10) will comprise in the lower half of a captured image a number of lines proportional to the height (h). The tangent of the angle (θ) is now equal to the opposite cathetus, (a)+(h), divided by the adjacent cathetus, (X). The distance (a)+(h) can be estimated by dividing the known height (h) by the number of lines of the wall (11) in the lower half of the captured image and multiplying by the number of lines of the visible part of the ground surface (8) to the wall (11) in the captured image. The angle (θ) is known. The distance (X) between the unmanned autonomous vehicle (1) and the wall (11) can then be estimated by dividing the estimated distance (a)+(h) by the tangent of the angle (θ). A height (Y) of the wall (11) can be estimated by determining a total number of lines of the wall (11) in the captured image, dividing this by the number of lines of the wall (11) in the lower half of the captured image, and then multiplying by the known height (h). The angle (β) between the bottom line (12) and the line (10) can then be estimated based on the estimated distance (X) and the height (h). The angle (λ) between the top line (12) and the line (10) can be estimated based on the estimated distance (X) and the height (Y)−(h).

It will be apparent to one skilled in the art that similar estimates can be made in a horizontal direction. It will also be apparent to one skilled in the art that if the wall (11) is not on the line (10) in a horizontal plane, the estimated distance (X) for an angle in a horizontal plane between the wall (11) and the line (10) must be corrected. It will also be apparent to one skilled in the art that if two different identical points are captured in the same image, for example the wall (11) and a tree that is not shown, a distance between the wall (11) and the tree can be estimated based on an estimate of the distance between the wall (11) and the unmanned autonomous vehicle (1), an estimate of the distance between the tree and the unmanned autonomous vehicle (1) and estimates of angles relative to the line (10) in a horizontal plane.

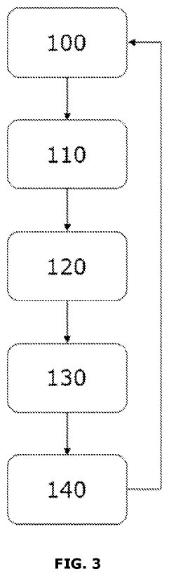

FIG. 3 shows a block diagram of a method according to an embodiment of the present invention.

In a first step (100), the unmanned autonomous vehicle (1) is moved along a perimeter in the terrain, capturing a first set of series of images of the terrain. The perimeter determines a defined part of the terrain.

In a second step (110) a map of the perimeter in the terrain is created based on the first set of images.

In a third step (120), the unmanned autonomous vehicle (1) uses the created map of the perimeter in the terrain to explore the demarcated part of the terrain, capturing a second set of images.

In a fourth step (130), a map of the terrain is created based on the first and second sets of images.

In a fifth step (140), the unmanned autonomous vehicle (1) navigates autonomously in the demarcated part of the terrain with the aid of the created map of the terrain. Preferably, the unmanned autonomous vehicle simultaneously performs a task in the demarcated part. If necessary, for example if the perimeter is changed or if the unmanned autonomous vehicle (1) is moved to another terrain, the method can be performed again from the first step (100).

1. A method for navigation of an unmanned autonomous vehicle in a demarcated part of a terrain, wherein the unmanned autonomous vehicle comprises a drive unit and a camera for taking images of the terrain, the drive unit having at least one wheel and a motor for driving the wheel and wherein the camera has a known viewing angle and a known position and alignment on the unmanned autonomous vehicle, comprising the steps of:
moving the unmanned autonomous vehicle on the terrain, wherein the camera simultaneously captures series of images of the terrain, wherein at least two images of a series comprise a number of identical points in the terrain;
creating a map of the terrain based on the series of images of the terrain;
autonomous navigation of the unmanned autonomous vehicle in a demarcated part of the terrain based on the created map of the terrain;
wherein the unmanned autonomous vehicle is first moved along a perimeter in the terrain, the perimeter defining the demarcated part of the terrain, wherein a first set of series of images of the terrain is captured, after which, based on the first set of series of images a map of the perimeter in the terrain is created, followed by the autonomous exploration of the demarcated part of the terrain based on the created map of the perimeter in the terrain, wherein a second set of series of images of the terrain is captured, after which the map of the terrain is created based on the first and second sets of series of images.

2. The method according to claim 1, wherein the unmanned autonomous vehicle is moved by following a person along the perimeter in the terrain, the unmanned autonomous vehicle capturing images of the person by means of the camera and wherein the person is recognized in the captured images using image recognition and followed by the unmanned autonomous vehicle.

3. The method according to claim 1, wherein the first and second sets of series of images are stored in the unmanned autonomous vehicle and processed in the unmanned autonomous vehicle for the creation of the map of the perimeter in the terrain and the map of the terrain.

4. The method according to claim 3, wherein the first and second sets of series of images are processed in the unmanned vehicle, while the unmanned autonomous vehicle is charged at a charging station.

5. The method according to claim 1, wherein the map of the terrain is absolutely scaled, the absolute scaling being done only on the basis of estimation of dimensions and/or distances from and/or between identical points in at least two images.

6. The method according to claim 5, wherein the unmanned autonomous vehicle comprises a sensor for measuring a number of revolutions of the at least one wheel of the unmanned autonomous vehicle, wherein the number of revolutions is used as a filter for estimates of dimensions and/or distances from and/or between identical points in at least two images.

7. The method according to claim 1, wherein exploring the demarcated part of the terrain follows a pattern of successively smaller loops within the perimeter, each loop being followed both clockwise and counterclockwise.

8. The method according to claim 1, wherein the unmanned autonomous vehicle recognizes a ground type by means of image recognition, wherein the unmanned autonomous vehicle compares the recognized ground type with a predetermined ground type and wherein, if when moving the unmanned autonomous vehicle along the perimeter in the terrain while capturing the first set of series of images of the terrain, a ground type different from the predefined ground type is recognized at a location in the terrain, a perimeter of a second demarcated part of the terrain is automatically determined.

9. The method according to claim 8, wherein the location in the terrain where a ground type different from the predetermined ground type has been recognized forms a passage for the unmanned autonomous vehicle to the second demarcated part of the terrain during autonomous navigation within the demarcated part of the terrain.

10. The method according to claim 1, wherein during the autonomous exploration of the demarcated part of the terrain, the unmanned autonomous vehicle exceeds the perimeter at most by a predetermined distance.

11. The method according to claim 10, wherein the unmanned autonomous vehicle recognizes ground types outside the perimeter by means of image recognition when exceeding the perimeter while autonomously exploring the demarcated part of the terrain, wherein the unmanned autonomous vehicle compares recognized ground types with predetermined ground types and/or with ground types on the perimeter and wherein the unmanned autonomous vehicle does not further exceed the perimeter if a recognized ground type does not correspond to a predetermined ground type and/or with a ground type on the perimeter.

12. The method according to claim 1, wherein during autonomous navigation in the demarcated part of the terrain, the unmanned autonomous vehicle follows a pattern of adjacent lines or concentric loops.

13. The method according to claim 1, wherein a person indicates parts of the perimeter on the map of the terrain, the unmanned autonomous vehicle navigating within the perimeter and on said parts of the perimeter during autonomous navigation.

14. Unmanned autonomous vehicle for navigation in a demarcated part of a terrain comprising a drive unit and a camera for taking images of the terrain, the drive unit comprising at least one wheel and a motor for driving the wheel and the camera having a known viewing angle and a known position and alignment on the unmanned autonomous vehicle, wherein the unmanned autonomous vehicle comprises a memory and a processor, the processor being configured to perform a method according to claim 1.

15. The unmanned autonomous vehicle according to claim 14, wherein the camera of the unmanned autonomous vehicle is only suitable for taking two-dimensional images.

16. The unmanned autonomous vehicle according to claim 14, wherein the unmanned autonomous vehicle comprises a sensor for measuring a number of revolutions of the at least one wheel of the unmanned autonomous vehicle.

17. The unmanned autonomous vehicle according to claim 14, wherein the camera has a fixed position on the unmanned autonomous vehicle.

18. Use of a method according to claim 1 for autonomous mowing of a lawn.

19. Use of an unmanned autonomous vehicle according to claim 14 for autonomous mowing of a lawn.
